(19) United States
(12) Patent Application Publication
(10) Pub. No.: US 2014/0367591 A1
(43) Pub. Date: Dec. 18, 2014

(54) MULTICOLOUR EXCITATION MODULE FOR A MULTIPHOTON IMAGING SYSTEM AND ASSOCIATED METHOD AND SYSTEM

(71) Applicants: ECOLE POLYTECHNIQUE, Palaiseau (FR); CENTRE NATIONAL DE LA RECHERCHE SCIENTIQUE, Paris (FR)

(72) Inventors: Pierre Mahou, Bures-Sur-Yvette (FR); Emmanuel Jean Marc Beaurepaire, Palaiseau (FR); Delphine Debarre, Grenoble (FR); Willy Supatto, Gif Sur Yvette (FR); Jean Louis Martin, Bures-sur-Yvette (FR)

(21) Appl. No.: 14/376,040

(22) PCT Filed: Feb. 1, 2013
(86) PCT No.: PCT/EP2013/052002

§ 371 Date: Jul. 31, 2014

(30) Foreign Application Priority Data
Feb. 2, 2012 (FR) 12 50990

(51) Int. Cl. G01N 21/64

(52) U.S. Cl. CPC G01N 21/6456; G01N 2201/06113; G01N 2201/0668
USPC 250/459.1; 250/458.1

(57) ABSTRACT

A module is provided for a multi-photon imaging system for simultaneously exciting chromophores of a specimen. A first femtosecond laser source emits a first pulsed excitation beam having a repetition rate 1/T and a wavelength λ₁ exciting a first chromophores, the absorbed photons originating from the first excitation beam. A second femtosecond laser source emits a second pulsed excitation beam with a wavelength λ₂ exciting a second chromophores, the absorbed photons originating from the second beam; the first beam including an “excitation” part exciting the specimen and a “pumping” part acting as a pump beam for exciting the second laser source to synchronize the second laser source with the first laser source. An optical delay line superimposes spatially and temporally the second beam and the excitation part of the first beam to excite at least a third chromophore, the absorbed photons originating from the first and second excitation beams.

### TECHNICAL FIELD

The present invention relates to a mufti-colour excitation module for a multi-photon imaging system. Reference is equally made to multi-photon or non-linear imaging, in particular multi-photon or non-linear microscopy.

The field of the invention is more particularly that of multi-colour excitation and multi-photon fluorescence imaging, i.e. the observation of return signals known as “fluorescence” return signals emitted by chromophores present in a specimen in response to the absorption of light from a pulsed excitation laser beam.

Typically, multi-photon imaging uses two- or three-photon excitation. It is particularly useful for in-depth non-destructive observation of biological tissues.

Chromophores may be present naturally in the specimen. Provision could also be made for them to be injected. Reference is also made, more precisely, to fluorophores, i.e. chemical substances capable of emitting fluorescent light after excitation.

The return signals are referred to as “fluorescence” signals, since they correspond to a light emission as a result of the excitation of a molecule (here by absorption of at least two photons).

The field of the invention is more particularly, but non-limitatively, that of two-photon microscopy.

The present invention also relates to a multi-colour multi-photon imaging system comprising an excitation module making it possible to excite several different chromophores, as well as a method implemented in said module.

### STATE OF THE PRIOR ART

Various multi-colour multi-photon excitation modules for a multi-photon imaging system capable of exciting at least three separate chromophores are known in the prior art.

A first solution consists of using at least one tuneable laser source to excite the chromophores. Emission wavelength scanning of the tuneable laser source makes it possible to excite the at least three different chromophores in succession. At least three images are successively obtained, each image corresponding to one chromophore, and these images can be superimposed.

The change in the emission wavelength of said laser source takes several seconds at best for narrow-spectrum pulsed femtosecond laser sources generally used in multi-photon imaging systems.

A disadvantage of this first solution is therefore that it is impossible to produce the return signals corresponding to each of said at least three chromophores simultaneously.

This disadvantage may be particularly limiting when imaging biological specimens in which rapid movements take place, occurring on the scale of a second. The superimposition of images is then difficult or even impossible to carry out.

A second solution consists of using a single laser source to simultaneously excite at least three separate chromophores having very close excitation frequencies.

A disadvantage of this second solution is that the range of excitation frequencies is limited, which reduces the range of chromophores capable of being excited efficiently. Only spectrally close sets of chromophores (for example about 10 nm between two excitation peaks) can be imaged simultaneously. Another disadvantage of this second solution is that it does not provide for independent control of the efficiency of excitation of the different chromophores.

A third solution consists of using one pulsed laser source per chromophore to be simultaneously excited.

A disadvantage of this third solution is of course its prohibitive cost, since at least three pulsed laser sources are required.

The object of the present invention is to propose a multi-colour multi-photon excitation module for a mufti-photon imaging system allowing at least three chromophores of a specimen to be imaged simultaneously, in which at least one of the disadvantages of the prior art is absent.

In particular, an object of the present invention is to propose a module for a multi-photon imaging system for efficiently exciting and simultaneously imaging at least three chromophores of a specimen.

Another object of the present invention is to propose a simple and inexpensive module for a multi-photon imaging system, for efficiently exciting at least three chromophores of a specimen.

Another object of the present invention is to propose a module for a multi-photon imaging system, for efficiently exciting at least three chromophores of a specimen, said three chromophores having excitation wavelengths distant from one another, for example at least 50 nm.

Finally, the purpose of the present invention is to propose a multi-photon imaging system comprising such a module as well as a method implemented in said module.

### DISCLOSURE OF THE INVENTION

This object is achieved with a module for a multi-photon imaging system for simultaneously exciting at least three chromophores of a specimen, said module comprising:
a first femtosecond laser source emitting a first excitation beam in the form of pulses having a repetition rate 1/T and a (central) wavelength λ₁ capable of exciting a first one of the chromophores by multi-photon absorption, said absorbed photons originating from the first excitation beam;
a second femtosecond laser source, emitting a second excitation beam in the form of pulses with a (central) wavelength λ₂ capable of exciting a second one of the chromophores by multi-photon absorption, said absorbed photons originating from the second excitation beam.

The first excitation beam comprises a part known as the “excitation” part acting to excite the specimen and a part known as a “pumping” part, this pumping part acting as a pump beam for synchronously exciting the second femtosecond laser source so that the second laser source is synchronous with the first laser source, i.e. with the same repetition rate 1/T.

The module according to the invention also comprises an optical delay line arranged to superimpose spatially and temporally the second excitation beam and the excitation part of the first excitation beam so as to excite at least a third one of the chromophores by multi-photon (two-colour) absorption, said absorbed photons originating from the first and second excitation beams.

For reasons of brevity, reference is made simply to absorption of photon(s) originating from the first excitation beam, rather than absorption of photon(s) originating from the excitation part of the first excitation beam.

Reference is made to “synchronous” excitation, since the excitation of the second laser source by a part of the first excitation beam ensures that the pulse trains of the two excitation beams have the same rate.

The second femtosecond laser source is thus formed synchronous with the first femtosecond laser source.

It is thus possible to superimpose spatially and temporally the first and second excitation beams. They are in fact similar by nature, but for a time lag. This time lag can be compensated by the optical delay line.

When speaking of spatial and temporal superimposition, this preferably means a spatial and temporal superimposition in the specimen to be studied.

Preferably, the optical delay line (referred to below simply as “delay line”) spatially and temporally superimposes the second excitation beam and the remaining part of the first excitation beam which is not used as a pump beam for the second laser source.

The delay line can be arranged in particular to adjust the optical path travelled by the excitation part of the first excitation beam so as to superimpose said excitation part on the second excitation beam at the output from the delay line.

Alternatively, the delay line can be arranged to adjust the optical path travelled by the second excitation beam so as to superimpose this beam on the excitation part of the first excitation beam at the output from the delay line.

The delay line can comprise mirrors mounted on a traverse in order to control a time lag between the second excitation beam and the excitation part of the first excitation beam.

Since the first and second excitation beams, at the output from the delay line, are superimposed spatially and temporally, it is possible to excite simultaneously at least three chromophores by an excitation implementing simultaneous absorptions of photons originating from:
the first excitation beam only;
the second excitation beam only or;
the first and second excitation beams at the same time.

Consequently, it is also possible to image simultaneously corresponding return signals known as “fluorescence” return signals:

It is thus possible to follow developments at a scale below a millisecond, return signals originating, for example, from biological specimens.

Since only two laser sources are needed for simultaneous imaging of at least three chromophores, the module according to the invention is inexpensive. The additional delay line does not involve real additional costs since it is a common commercial optical element.

Since the at least three respective chrornophores can be excited by multi-photon absorption of several photons originating from:
the first excitation beam only;
the second excitation beam only or;
the first and second excitation beams at the same time;

it is possible to excite chromophores having very varied absorption wavelengths (for example at least 50 nm between two excitation wavelengths) depending on the choice of the first and the second laser source. It is possible for example to image rapidly and efficiently tissues marked with several fluorescent proteins the emissions of which go from blue to red.

A femtosecond (fs) source produces ultra-short pulses the duration of which is generally of the order of a few hundred fs (1 fs=10⁻¹⁵ seconds).

The simultaneous excitation of the chromophores also makes their simultaneous detection possible. It is thus possible to image the at least three chromophores belonging to a specimen in which rapid movements are produced, present at the scale of a second, without being affected by these movements during a comparison of images or signals obtained for each chromophore.

According to a particularly advantageous embodiment, separation means are arranged upstream of the second femtosecond laser source for separating the first excitation beam into the excitation part and the pumping part.

The terms “upstream” and “downstream” refer to the direction of propagation of the first excitation beam.

The separation means can comprise a dichroic mirror for separating:
on the one hand, the pumping part of the first excitation beam;
on the other hand, the excitation part of the first excitation beam.

The term “separate” used in no case presupposes directions of propagation of the pumping part on the one hand and the excitation part on the other hand.

The delay line can then comprise in particular a combining element such as a dichroic mirror, arranged downstream of the second femtosecond laser source, to replace the delayed excitation beam on the same optical path as the non-delayed excitation beam.

The delay line is preferably arranged outside the second femtosecond laser source.

Consideration can also be given to the excitation part and the pumping part of the first excitation beam being at least partially merged. The first excitation beam passes through the second ferntosecond laser source, then acting as a pump beam. Upon output, it is at least partially reused as an excitation beam. In this case, it is possible to do without said separation means.

The delay line can then be positioned directly inside the second femtosecond laser source.

Alternatively, the delay line can be downstream of the second femtosecond laser source. In this case, means must be provided for separating the first excitation beam and the second excitation beam at the output from the second laser source. One of the two excitation beams is brought to the delay line. Next, the two excitation beams are recombined.

Preferably, the first femtosecond laser source is formed by an oscillator, for example a Titanium Sapphire (TiS) laser or a fibre laser.

This type of femtosecond laser has a broad emission spectrum in the near infrared, often centred around 800 nm.

The second femtosecond laser source can be formed by an optical parametric oscillator (OPO). An optical parametric oscillator is a source implementing non-linear optical interactions from a pump signal formed here by a part of the first excitation beam emitted by the first femtosecond laser source. An advantage of OPOs is that they provide access to wavelengths which are difficult to achieve (having a wavelength above 1000 nm) with other types of laser sources. Since the OPO is pumped by the first femtosecond excitation beam, it can in its turn emit a second excitation beam, also femtosecond.

Preferably, the module according to the invention is suitable for exciting chromophores emitting return signals known as “fluorescence” return signals, spaced at least 50 nm from one another, wherein each return signal is expressed in units of wavelength.

Each return signal has a peak centred on a wavelength which is taken into account for measuring said spacing of at least 50 nm.

The module according to the invention can also comprise at least one telescope arranged to implement a spatial overlap, in the specimen, of the second excitation beam and of the excitation part of the first excitation beam.

The at least one telescope is preferably arranged on the optical path of one from the second excitation beam and the excitation part of the first excitation beam.

For example, the telescope can form part of the delay line.

Advantageously, a telescope can be provided on the optical path of the second excitation beam only, and a telescope on the optical path of the excitation part of the first excitation beam only.

The second and the first excitation beams have different wavelengths. In the absence of a particular measurement and when these wavelengths are very far apart from one another (for example more than 300 nm), they could each be focused to a different depth in the specimen. Spatial overlap of the two excitation beams in the specimen would not then be implemented. It would therefore not be possible to obtain a return signal corresponding to the absorption of at least one photon of the first excitation signal and at least one photon of the second excitation signal.

The at least one telescope makes it possible in particular to control independently the relative sizes and divergence of the second excitation beam and of the excitation part of the first excitation beam. It is thus possible to correct any offset in the second excitation beam and the excitation part of the first excitation beam in the axis of the depth of the specimen.

According to an advantageous embodiment of the module according to the invention:
the first femtosecond laser source emits a first excitation beam at a (central) wavelength λ₁ capable of exciting a first one of the chromophores by two-photon absorption, said absorbed photons originating from the first excitation beam;
the second laser source emits a second excitation beam at a (central) wavelength λ₂ capable of exciting a second one of the chromophores by two-photon absorption, said absorbed photons originating from the second excitation beam; and
the optical delay line is arranged to superimpose spatially and temporally the second excitation beam and the excitation part of the first excitation beam so as to excite a third one of the chromophores by two-photon absorption, the two photons originating one from the first excitation beam and the other from the second excitation beam.

Two-photon absorption phenomena are thus implemented (reference is also made to “2PEF” for “2-Photon Excited Fluorescence”), which are most commonly used in particular in the field of multi-photon microscopy.

This embodiment is non-limitative and, for example, it is also possible to envisage the implementation of three-photon absorption phenomena (reference is also made to “3PEF” (3-Photon Excited Fluorescence)).

The invention also relates to a multi-photon imaging system comprising a module according to the invention, and also comprising detection means having at least three channels, each channel being arranged to detect a respective return signal associated with a corresponding multi-photon absorption.

The number of channels depends on the number of chromophores detected (the expression “number of chromophores” denotes a number of types of chromophores). The number of chromophores able to be detected itself depends on the number of photons implemented by the multi-photon absorption (it is considered that each chromophore can be excited by a separate wavelength). For a two-photon absorption, three combinations are possible (photons A-A, photons B-B, photons A-B) and therefore the system according to the invention comprises three channels. For a three-photon absorption, four combinations are possible (photons A-A-A, photons A-A-B, photons A-B-B, photons B-B-B) and therefore the system according to the invention comprises four channels.

Since the detection of the different return signals is simultaneous, in the event that the spectrum width of a channel is such that it also detects a 0.5 part of a return signal which is spectrally adjacent, the signals received by each of the channels can be processed so as to separate for each channel a dedicated return signal and a spurious return signal corresponding to the return signal dedicated to a spectrally adjacent channel.

According to a preferred embodiment of the multi-photon imaging system according to the invention, it comprises in particular detection means having three channels,
a first channel corresponding to a first two-photon absorption, the two absorbed photons originating from the first excitation beam;
a second channel corresponding to a second two-photon absorption, the two absorbed photons originating from the second excitation beam; and
a third channel corresponding to a third two-photon absorption, the two absorbed photons originating one from the first excitation beam (20) and the other from the second excitation beam.

Preferably, the multi-photon imaging system according to the invention forms a system from:
an endoscope;
a microscope;
a confocal microscope;
a multi-point light microscope;
a light sheet microscope;
a macroscopic imaging system.

It can thus be seen that the invention is not limited to one application in particular, but can be applied to various multi-photon imaging geometries.

The invention also relates to a method implemented in a module according to the invention. According to this method, the setting of the delay line is adjusted so as to superimpose spatially and temporally the second excitation beam and the excitation part of the first excitation beam, while detecting the appearance of a return signal corresponding to the excitation of at least a third one of the chromophores by multi-photon absorption, said absorbed photons originating from the first and second excitation beams.

In fact, the excitation of said at least third one of the chromophores assumes a simultaneous absorption by said chromophore of at least one photon originating from the first excitation beam and at least one photon originating from the excitation part of the first excitation beam. To this end it is therefore necessary for the second excitation beam and the excitation part of the first excitation beam to be superimposed spatially and temporally. The setting of the delay line is therefore particularly simple to implement.

According to a preferred embodiment of the method according to the invention, this method implements two-photon absorptions, and three return signals are detected, corresponding respectively to:
a two-photon absorption, the two absorbed photons originating from the first excitation beam;
a two-photon absorption, the two absorbed photons originating from the second excitation beam; and
a two-photon absorption, the two absorbed photons originating one from the first excitation beam and the other from the second excitation beam.

In this preferred embodiment, it is possible to adjust the relative intensity of the return signal corresponding to a two-photon absorption, the two absorbed photons originating one from the first excitation beam and the other from the second excitation beam, by adjusting the setting of the delay line.

In fact, depending on whether the second excitation beam and the excitation part of the first excitation beam are perfectly or otherwise superimposed spatially and temporally, the probability of simultaneous absorptions of a photon from each of the two excitation beams is more or less high. It follows that the intensity of the corresponding return signal is more or less high. It is therefore possible to adjust the intensity of said return signal without modifying the intensities of the two other return signals corresponding respectively to the absorption of two photons from the first excitation signal or two photons from the second excitation signal.

In particular, in this same preferred embodiment, it is possible to adjust independently the relative intensity of the three return signals by adjusting respectively:
the output intensity of the first femtosecond laser source;
the output intensity of the second femtosecond laser source; and
the setting of the delay line.

It can therefore be seen that the embodiment of the invention associated with two-photon absorptions is particularly advantageous, since it provides for these independent adjustments of each of the return signals.

The method according to the invention can be implemented to excite chromophores emitting return signals known as “fluorescence” return signals spaced at least 50 nm from one another, wherein each return signal is expressed in units of wavelength.

### DESCRIPTION OF FIGURES AND EMBODIMENTS

Other advantages and characteristics of the invention will become apparent on examination of the detailed description of embodiments which are in no way limitative, and the following attached diagrams:

FIG. 1 shows an embodiment of a module and system according to the invention;

FIG. 2 shows the first and second excitation beams in the absence of a delay line implementing their spatial and temporal superimposition;

FIGS. 3A to 3D show the multi-photon absorptions implemented in an embodiment of a module and system according to the invention;

FIG. 4 shows excitation spectrums of different fluorescent proteins;

FIGS. 5A and 5B show different acquisitions which can be obtained thanks to the module and system according to the invention;

FIG. 6 shows excitation spectrums of different fluorescent proteins, and the detection spectrum widths of the associated detection channels;

FIG. 7 shows return signals acquired in a system according to the invention, by varying a time delay between the first and second excitation beams; and

FIGS. 8A to 8D show a test for optimum spatial overlap between the first and the second excitation beam.

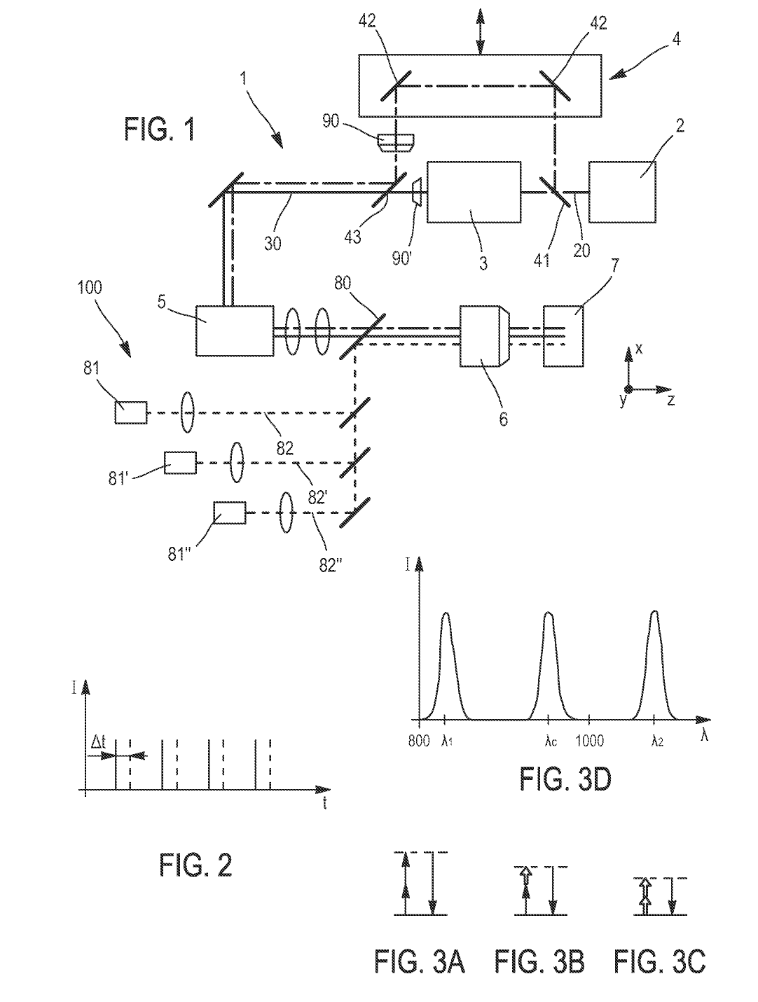

A description will first be given, by reference to FIG. 1, of a first embodiment of module 1 for a multi-photon imaging system 100.

Hereinafter, the example of a module 1 according to the invention will be developed, for the simultaneous imaging of three chromophores of a specimen thanks to two-photon absorptions. However, this example is in no way limitative and it could be envisaged for the module and the imaging system according to the invention to be implemented in the context of three-photon absorption at least, with a view to simultaneously imaging four chromophores at least of a specimen.

When referring to a chromophore, a given substance is denoted (and not an individual molecule).

The module 1 according to the invention comprises a titanium-sapphire oscillator 2 (Ti:S) emitting a first excitation beam 20 at wavelength λ₁ equal to 820 nm. The Ti:sapphire oscillator 2 is a femtosecond laser, i.e. emitting a pulsed signal the pulses of which have a width of the order of around ten or around a hundred femtoseconds. The emission wavelength λ₁ of this oscillator is selected in particular to be able to excite by multi-photon absorption at least one chromophore of a specimen to be studied. The Ti:sapphire osciilator 2 (Ti:S) must be excited by an excitation diode. The module 1 according to the invention comprises only one single excitation diode.

A part of the first excitation beam 20 is brought to an optical parametric oscillator (OPO) 3 to act as a pump beam. A dichroic mirror 41 arranged at 45° (angle in degrees where 180° equals π radians) on the optical path of the first excitation beam 20 upstream of the OPO separates on the one hand this part known as the “pumping” part of the first excitation beam and, on the other hand, by a part known as the “excitation” part of the first excitation beam.

The optical parametric oscillator (OPO) 3 then emits a second excitation beam 30 at a wavelength λ₂ equal to 1180 nm. The emission wavelength λ₂ of this oscillator is selected in particular to be able to excite by multi-photon absorption at least one chromophore of a specimen to be studied.

The two emission wavelengths λ₁ and λ₂ of these oscillators are selected in particular to be able to excite, by multi-photon absorption mixing these two wavelengths, at least one chromophore of a specimen to be studied.

The dichroic mirror 41 arranged at 45° on the optical path of the first excitation beam 20 directs the excitation part of the first excitation beam to a delay line 4 of the module 1 according to the invention.

The delay line 4 comprises at least two reflectors 42 defining an additional optical path for the excitation part of the first excitation beam 20.

The delay line also comprises a second dichroic mirror 43, arranged to replace on the same optical path the second excitation beam 30 and the excitation part of the first excitation beam 20. The dichroic mirror 43 is arranged at 45° on the optical path of the second excitation beam and the excitation part of the first excitation beam. The second excitation beam passes through the dichroic mirror 43 without being deflected. The excitation part of the first excitation beam is deflected at 90° by the dichroic mirror 43.

Hereinafter in the description of the Figures, and for reasons of brevity, the part of the first excitation beam 20 which has been brought to the delay line 4 will simply be called “first excitation beam 20”.

In FIG. 1, for reasons of clarity of the figure, the second excitation beam 30 and the first excitation beam 20 are not superimposed. In reality, these two beams are quite obviously superimposed spatially.

It is possible to make provision for optical elements such as a telescope 90 inside the delay line 4 in order to ensure spatial overlap of the pulses, by controlling the size and divergence of the excitation part of the first excitation beam independently of the second excitation beam.

In the example represented in FIG. 1, a second telescope 90′ is also arranged on the optical path of the second excitation beam only, upstream of the second dichroic mirror 43.

Each telescope 90, 90′ makes it possible to adjust independently the divergence of each excitation beam, and preferably, also independently, the size of the beams.

It is possible to use, for example, telescopes with three or four lenses. It could also be envisaged for these beam processing systems to be based on active or adaptive optical elements.

The invention consists of superimposing in space and time at least two pulse trains with different wavelengths (first and second excitation beams) in a multi-photon imaging system such as a multi-photon microscope.

Thanks to such superimposition, different types of chromophores of a specimen can simultaneously emit a fluorescence signal in response to the absorption respectively of two photons of the first pulse train, two photons of the second pulse train or two photons each originating from one of the two pulse trains.

A description will now be given, still with reference to FIG. 1, of the elements of the multi-photon imaging system 100 according to the invention, apart from module 1 which has just been described.

At the output from the second dichroic mirror 43, the first and second excitation beams 20, 30 are directed to scanning means 5 in the plane (xOy), then scanning means 6 along axis (Oz) corresponding to the axis of the depth of a specimen 7.

The scanning means 6 also comprise focusing optics to focus the excitation signals at a desired point in the specimen 7.

The specimen 7 comprises at least three chromophores emitting a fluorescence signal in response to the absorption of:
two photons at 820 nm;
two photons at 1180 nm; or
one photon at 820 nm and one photon at 1180 nm.

The different fluorescence signals are emitted in reflection. A dichroic mirror 80 deflects them to a detection stage comprising a respective channel 81, 81′, 81″ for each of the three fluorescence signals 82, 82′, 82″.

It is thus possible to detect at the same time the signals produced by an oscillator taken individually, and the signal produced by mixing frequencies between these two oscillators.

It is thus possible, with an excitation chain comprising two synchronized lasers, to excite simultaneously three types of chromophores which are spectrally very different. Reference may be made in particular to multi-colour multi-photon imaging by synchronized pulses or multi-colour multi-photon imaging by combination of frequencies.

It is possible in particular to image simultaneously three signals of blue, yellow and red or blue, green and red fluorescent proteins.

FIG. 2 allows the principle implemented according to the invention to be shown. FIG. 2 shows the pulse trains as a function of time and, in the absence of a delay line 4, of the first excitation beam 20 (solid lines and of the second excitation beam 30 (dotted lines). The delay line makes it possible in particular to abolish the time gap Δt between the two pulse trains.

It can be seen that the invention makes it possible to excite simultaneously:
(see FIG. 3A) a chromophore absorbing two photons of the first excitation beam 20, producing a return signal at the wavelength λ₁/2, i.e. 410 nm (blue) in the example developed here;
(see FIG. 3C) a chromophore absorbing two photons of the second excitation beam 30, producing a return signal at the wavelength λ₂/2, i.e. 590 nm (red) in the example developed here;
(see FIG. 3B) a chromophore absorbing one photon of the first excitation beam 20 and one photon of the second excitation beam 30, producing a return signal at the wavelength

$$\frac{1}{\frac{1}{{λ}_{1}} + \frac{1}{{λ}_{2}}} ,$$

i.e. 484 nm (yellow) in the example developed here, which would correspond to an absorption of two photons of a central excitation beam at the wavelength 968 nm. Reference is therefore made here to a third, virtual, excitation beam.

FIG. 3D shows the excitation signals used, in particular the virtual excitation signal recreated artificially thanks to the invention. The X-axis corresponds to a wavelength in nm, the Y-axis to an intensity in arbitrary units.

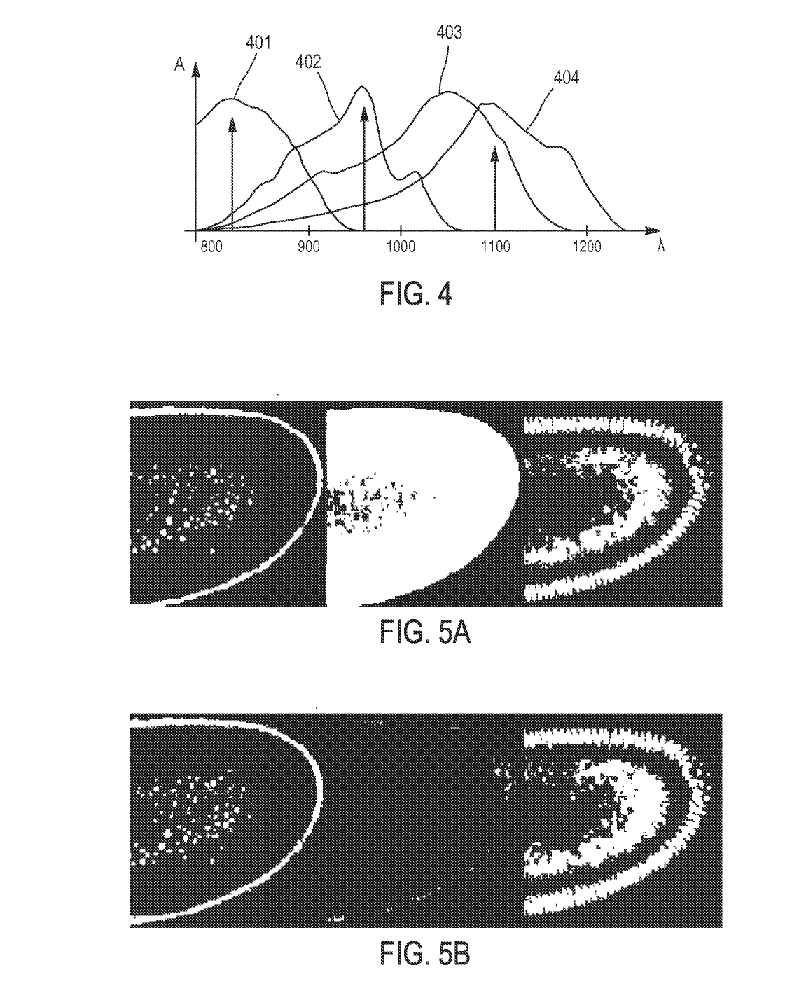

FIG. 4 shows the following on an X-axis corresponding to a wavelength expressed in nm (nanometres
the excitation spectrum (Y-axis in arbitrary units, corresponding to an absorbed power) of different fluorescent proteins; and
the excitation signals (Y-axis in arbitrary units, corresponding to a light intensity), in particular the virtual excitation signal recreated artificially thanks to the invention.

It can be seen that the excitation signals obtained artificially or otherwise according to the invention correspond to absorption peaks of several fluorescent proteins, which will thus be able to be imaged thanks to a module 1 and a multi-photon imaging system 100 according to the invention.

Curve 401 corresponds to an eCFP protein (Enhanced Cyan Fluorescent Protein, i.e. a protein emitting a blue cyan “fluorescence” return signal).

Curve 402 corresponds to an eYFP protein (Enhanced Yellow Fluorescent Protein, i.e. a protein emitting a yellow “fluorescence” return signal).

Curve 403 corresponds to a tdTomato protein (a protein emitting a bright red “fluorescence” return signal).

Curve 404 corresponds to a mCherry protein (a protein emitting a cherry red “fluorescence” return signal).

It has been possible, for example, to image mouse brain tissue marked by these different proteins. The term “brainbow technique” denotes this mark technique.

Each excitation wavelength (in particular the wavelength known as “virtual” wavelength corresponding to said central excitation signal) can excite several different types of chromophores. This is apparent here for the signal at 1100 nm, which corresponds to a maximum absorption for both mCherry and tdTomato proteins.

Reference may be made in the table below to different groups of three chromophores which can be imaged simultaneously thanks to a module 1 and a multi-photon imaging system 100 according to the invention.

The names of the chromophores are shown in parentheses, separated by commas when several chromophores can be used.

| | | Wavelength of the |
|---|---|---|
| | Wavelength of the | virtual excitation signal |
| | second | recreated artificially |
| Wavelength of the first | excitation beam | thanks to the invention |
| excitation beam (λ₁) | (λ₂) | (λ_{c}) |
| 880 nm | 1000 nm | 1150 nm |
| (mTFP1, Dendra2 Green) | (Dendra2 Red) | (mKate2) |
| 760 nm | 900 nm | 1100 nm |
| (DAPI) | (mTFP1) | (mCherry) |
| 850 nm | 950 nm | 1080 nm |
| (CFP) | (GFP, YFP) | (mRFP, DsREd, |
| | | tTomato) |

A description will now be given with reference to FIGS. 5A and 5B of a method for setting the delay line 4 according to the invention.

It can be seen in FIG. 1 that the reflectors 42 of the delay line 4 can be mounted on a motorized traverse so as to be able to adjust the setting of said delay line in order best to superimpose the two excitation beams 20, 30.

Controlling the delay induced by the delay line 4 on the first excitation beam 20 also provides a means for adjusting the light intensity of the return signal obtained by frequency mixing (absorption of two photons, one originating from the first excitation beam and the other originating from the second excitation beam) independently of the return signals only depending on one single excitation beam. Furthermore, the existence of a third return signal obtained by frequency mixing confirms that the first and second excitation signals are spatially and temporally superimposed with a precision equal to the resolution of the multi-photon imaging system 100. It can therefore be seen that the invention offers an “alignment test” which is particularly simple to implement.

Controlling the mean power of the two excitation beams also makes it possible to control the relative intensities of the three return signals.

The intensities of the return signals known as fluorescence return signals are in effect respectively proportional to:
P₁², where P₁ is the mean power of the excitation part of the first excitation beam 20 (absorption of two photons of the first excitation beam);
P₂² where P₂ is the mean power of the second excitation beam 30 (absorption of two photons of the second excitation beam);
2P₁P₂g(τ) where τ is the delay between the two pulse trains respectively of the first and of the second excitation beam, downstream of the delay line (absorption of two photons, one of the excitation part of the first excitation beam and the other of the second excitation beam), and g is the temporal inter-correlation function of the two excitation beams, proportional to exp(−τ²) in the case of excitation beams with Gaussian time profiles.

This principle is shown in FIGS. 5A and 5B, which each present from right to left:
the image obtained thanks to the return signal corresponding to an absorption of two photons of the first excitation beam;
the image obtained thanks to the return signal corresponding to an absorption of two photons, one of the first excitation beam and the other of the second excitation beam; and
the image obtained thanks to the return signal corresponding to an absorption of two photons of the second excitation beam.

The specimen imaged is a drosophila with a triple fluorescent blue, green and red marking.

In FIG. 5A, the pulses of the first and of the second excitation beam are perfectly synchronized by the delay line (τ=0 fs).

The central image then shows the presence of a strong return signal corresponding to an absorption of two photons, one of the first excitation beam and the other of the second excitation beam.

In FIG. 5B, the pulses of the first and of the second excitation beam are not perfectly synchronized (τ=350 fs).

The central image then shows the presence of a very weak return signal corresponding to an absorption of two photons, one from the first excitation beam and the other from the second excitation beam.

This result can also be used to compensate for the interference effects known as “cross-talk” between the first and second excitation beams, which tend to reduce the relative intensity of the return signal corresponding to an absorption of two photons, one from the first excitation beam and the other from the second excitation beam.

This principle can also be used to maintain the absolute intensities of the three return signals as detected constant over time during in-depth scanning of a specimen (consequently varying a coefficient of attenuation of the excitation beams and return signals).

The acquisitions are obtained with pixels of dimensions 0.8×0.8×3 μm³. For example, images are produced in three dimensions thanks to scanning in the direction of the depth of the specimen, for example one image in three dimensions every 45 seconds.

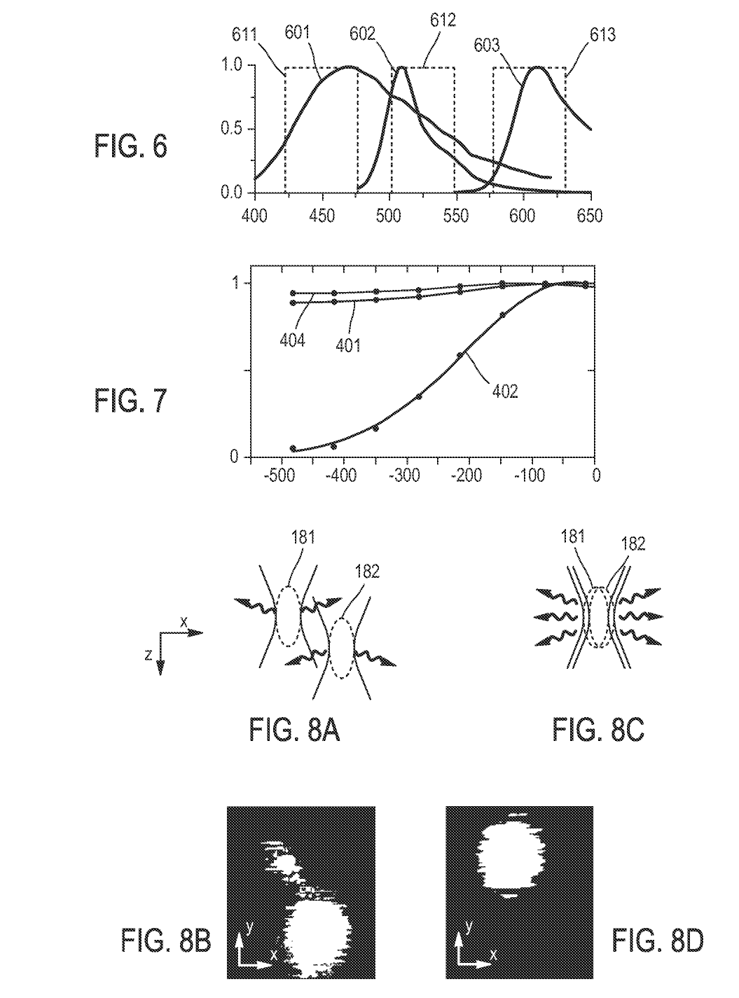

FIG. 6 shows an additional advantage of a simultaneous multi-channel detection.

The X-axis corresponds to a wavelength in nm.

The Y-axis corresponds to a return signal intensity in arbitrary units.

Curves 601, 602 and 603 correspond to return signal spectrums.

Curve 601 corresponds to an endoprotein emitting a blue “fluorescence” return signal.

Curve 602 corresponds to a GFP protein (Green Fluorescent Protein), i.e. a protein emitting a green “fluorescence” return signal.

Curve 603 corresponds to an RFP protein (Red Fluorescent Protein), i.e. a protein emitting a red “fluorescence” return signal.

The intervals 611, 612, 613 shown in dotted lines correspond respectively to:
the spectral width detected by the detection channel dedicated to the blue return signal;
the spectral width detected by the detection channel dedicated to the green return signal;
the spectral width detected by the detection channel dedicated to the red return signal.

Since the emission is simultaneous, so too is the detection. It is therefore possible, for each channel (here more particularly for the channel corresponding to interval 612), to separate the contributions of the different return signals.

In order to separate the contributions of two chromophores A and B in channels C1 and C2, the following linear equation is solved:

$$( \begin{matrix}C 1 \\ \\ C 2\end{matrix} ) = ( \begin{matrix}RA 1 & RB 1 \\ & \\ RA 2 & RB 2\end{matrix} ) ( \begin{matrix}A \\ \\ B\end{matrix} ) ,$$

where
RA1, respectively RA2, is the normalized contribution (known) of chromophore A in channel C1 respectively C2, and
RB1, respectively RB2, is the normalized contribution (known) of chromophore A in channel C1 respectively C2,
C1 and C2 are measured intensities,
A and B are intensities to be determined.

FIG. 7 shows the return signals 404, 401 and 402 of FIG. 4. The X-axis corresponds to delay τ in femtoseconds between the second excitation beam and the excitation part of the first excitation beam at the output from the delay line.

The Y-axis corresponds to the intensity in arbitrary units.

As seen above, this shows the fact that the appearance of an additional return signal (corresponding to a multi-photon absorption of photons originating at the same time from the first and from the second excitation beam) indicates optimum adjustment of the temporal overlap between the first and second excitation beams.

FIGS. 8A to 8D show more particularly a test for optimum spatial overlap between the second excitation beam and the excitation part of the first excitation beam, downstream of the delay line. The particular example of a two-photon absorption is used, with emission of:
a red return signal corresponding to the absorption of two photons of the same excitation beam;
a blue return signal corresponding to the absorption of two photons of the same excitation beam; and
if necessary, a green return signal corresponding to the absorption of one photon of the first excitation signal and one photon of the second excitation signal,

FIG. 8A shows focusing zones 81 and 82 respectively of the first and of the second excitation beam, when the spatial overlap is not implemented between these two beams.

FIG. 8B shows the image obtained in this case. Two separate signals are obtained, one red and the other blue.

FIG. 8C shows focusing zones 181 and 182 respectively of the first and of the second excitation beam, when the spatial overlap is implemented between these two beams.

FIG. 8D shows the image obtained in this case. A single white signal is obtained, corresponding to the superimposition of three separate signals, red, blue and green.

It can thus be seen that observation of the image obtained allows optimum adjustment of the spatial overlap between the first and the second excitation beams.

According to the prior art, the blue return signal and the red return signal are successively acquired and then the images corresponding to these signals are superimposed on one and the same image. However, owing to possible chromatic aberrations in the focusing optics 6, the images corresponding respectively to the red signal and to the blue signal may be distorted, and distorted in different ways, in particular at the edge of the field of view (such distortions originate from the impact on the corresponding excitation signals of the chromatic aberrations presented by the focusing optics 6). In practice, the centre of the field of view is used. Then, by adjusting telescopes 90 and 90′, an offset between the focusing distance of the first excitation signal and that of the second excitation signal is removed. For this purpose, it is sought to detect a blue signal and a red signal originating from the same focusing plane (each of the two signals corresponding to a multi-photon absorption of several photons originating from the same excitation signal).

The time lag between the two excitation signals is then removed thanks to the delay line. The appearance of a third signal corresponding to a multi-photon absorption of at least one photon of the first excitation signal and at least one photon of the second excitation signal indicates when the lag is removed. For this step, the return signals are still observed at the centre of the field of view, where they are not distorted by chromatic aberrations.

Finally, it is possible to verify at the edge of the field of view from what angle the chromatic aberrations of the focusing optics start to hamper a good overlap of the two excitation signals, by using the test shown in FIGS. 8A to 8D. More precisely, this means moving gradually away from the centre of the field of view and noting the disappearance of the third return signal.

Thanks to the invention, a final image is obtained which groups the different return signals far closer to reality. In fact, the absence of the third return signal shows that a zone of the field of view has been reached which corresponds to distorted red and blue images. This part of the return signal can therefore be eliminated and only the return signal not affected by chromatic aberrations retained.

Of course, the invention is not limited to the examples which have just been described and numerous adjustments can be made to these examples without exceeding the scope of the invention.

In particular, all the characteristics, forms, variants and embodiments described above can be combined together in various combinations in so far as they are not incompatible or mutually exclusive.

1. A module for a multi-photon imaging system for simultaneously exciting at least three chromophores of a specimen, said module comprising:
a first femtosecond laser source emitting a first excitation beam in the form of pulses having a repetition rate 1/T and a wavelength λ₁ capable of exciting a first one of the chromophores by multi-photon absorption, said absorbed photons originating from the first excitation beam;
a second femtosecond laser source, emitting a second excitation beam (30) in the form of pulses with a wavelength λ₂ capable of exciting a second one of the chromophores by multi-photon absorption, said absorbed photons originating from the second excitation beam;
the first excitation beam including a part known as an “excitation” part acting to excite the specimen and a part known as a “pumping” part, this pumping part acting as a pump beam for synchronously exciting the second femtosecond laser source so that the second laser source is synchronous with the first laser source, i.e. with the same repetition rate 1/T; and
an optical delay line is arranged to superimpose spatially and temporally the second excitation beam and the excitation part of the first excitation beam so as to excite at least a third one of the chromophores by multi-photon absorption, said absorbed photons originating from the first and second excitation beams.

2. The module according to claim 1, characterized by separation means arranged upstream of the second femtosecond laser source for separating the first excitation beam into the excitation part and the pumping part.

3. The module according to claim 1, characterized in that the first femtosecond laser source is formed by a Titanium Sapphire (TiS) laser or a fibre laser.

4. The module according to claim 1, characterized in that the second femtosecond laser source is formed by an optical parametric oscillator (OPO).

5. The module according to claim 1, characterized in that it is suitable for exciting chromophores emitting return signals known as “fluorescence” return signals, spaced at least 50 nm from one another, wherein each return signal is expressed in units of wavelength.

6. The module according to any one of claim 1, characterized in that it also comprises at least one telescope arranged to implement a spatial overlap, in the specimen, of the second excitation beam and of the excitation part of the first excitation beam.

7. The module according to claim 1, characterized in that
the first femtosecond laser source emits a first excitation beam at a wavelength λ₁ capable of exciting a first one of the chromophores by two-photon absorption, said absorbed photons originating from the first excitation beam;
the second femtosecond laser source emits a second excitation beam at a wavelength λ₂ capable of exciting a second one of the chromophores by two-photon absorption, said absorbed photons originating from the second excitation beam; and
the optical delay line is arranged to superimpose spatially and temporally the second excitation beam and the excitation part of the first excitation beam so as to excite a third one of the chromophores by two-photon absorption, the two photons originating one from the first excitation beam and the other from the second excitation beam.

8. A multi-photon imaging system comprising a module according to claim 1, further including detection means having at least three channels, each channel being arranged to detect a respective return signal associated with a corresponding multi-photon absorption.

9. The multi-photon imaging system according to claim 8, characterized in that it comprises in particular detection means having three channels,
a first channel corresponding to a first two-photon absorption, the two absorbed photons originating from the first excitation beam;
a second channel corresponding to a second two-photon absorption, the two absorbed photons originating from the second excitation beam; and
a third channel corresponding to a third two-photon absorption, the two absorbed photons originating one from the first excitation beam and the other from the second excitation beam.

10. The multi-photon imaging system according to claim 8, characterized in that it forms a system from:
an endoscope;
a microscope;
a confocal microscope;
a multi-point light microscope;
a light sheet microscope; or
a macroscopic imaging system.

11. A method implemented in a module according to claim 1, characterized in that the setting of the delay line is adjusted so as to superimpose spatially and temporally the second excitation beam and the excitation part of the first excitation beam, while detecting the appearance of a return signal corresponding to the excitation of at least a third one of the chromophores by multi-photon absorption, said absorbed photons originating from the first and second excitation beams.

12. The method according to claim 11, characterized in that it implements two-photon absorptions and in that it detects three return signals corresponding respectively to:
a two-photon absorption, the two absorbed photons originating from the first excitation beam;
a two-photon absorption, the two absorbed photons originating from the second excitation beam; and
a two-photon absorption, the two absorbed photons originating one from the first excitation beam and the other from the second excitation beam.

13. The method according to claim 12, characterized in that adjustment is made of the relative intensity of the return signal corresponding to a two-photon absorption, the two absorbed photons originating one from the first excitation beam and the other from the second excitation beam, by adjusting the setting of the delay line.

14. The method according to claim 13, characterized in that the relative intensity of the three return signals is independently adjusted by adjusting respectively:
the output intensity of the first femtosecond laser source;
the output intensity of the second femtosecond laser source; and
the setting of the delay line.

15. The method according to claim 11, characterized in that it is implemented to excite chromophores emitting return signals known as “fluorescence” return signals spaced at least 50 nm from one another, wherein each return signal is expressed in units of wavelength.
